(19) United States
(12) Patent Application Publication
(10) Pub. No.: US 2002/0032844 A1
(43) Pub. Date: Mar. 14, 2002

(54) Distributed shared memory management

(76) Inventor: Karlon K. West, Austin, TX (US)

Correspondence Address: John J. Bruckner, Fulbright & Jaworski L.L.P., Suite 2400, 600 Congress Avenue, Austin, TX, 78701, US

(21) Appl. No.: 09/912,872

(22) Filed: Jul. 25, 2001

Related U.S. Application Data
(60) Provisional application No. 60/220,974, filed on Jul. 26, 2000.
(60) Provisional application No. 60/220,748, filed on Jul. 26, 2000.

(51) Int. Cl. G06F 13/00

(52) U.S. Cl. 711/171

(57) ABSTRACT

Systems and methods are described for distributed shared memory management. A method includes receiving a request from a requesting software to allocate a segment of memory; scanning a data structure for a smallest suitable class size, the data structure including a list of memory address size classes, each memory address size class having a plurality of memory addresses; determining whether the smallest suitable size class is found; if the smallest suitable size class is found, determining whether memory of the smallest suitable size class is available in the data structure; if the smallest suitable size class is found, and if memory of the smallest suitable size class is available, selecting a memory address from among those memory addresses belonging to the smallest suitable size class; and if the smallest suitable size class is found, and if memory of the smallest suitable size class is available in the data structure returning the memory address to the requesting software. An apparatus includes a processor; a private memory coupled to the processor; and a data structure stored in the private memory, the data structure including a list of memory address size classes wherein each memory address size class includes a plurality of memory addresses.

### CROSS-REFERENCES TO RELATED APPLICATIONS

This application is a continuation-in-part of, and claims a benefit of priority under 35 U.S.C. 119(e) and/or 35 U.S.C. 120 from, copending U.S. Ser. No. 60/220,974, filed Jul. 26, 2000, and 60/220,748, also filed Jul. 26, 2000, the entire contents of both of which are hereby expressly incorporated by reference for all purposes.

### BACKGROUND OF THE INVENTION

1. Field of the Invention

The invention relates generally to the field of computer systems. More particularly, the invention relates to computer systems where one or more Central Processing Units (CPUs) are connected to one or more Random Access Memory (RAM) subsystems, or portions thereof.

2. Discussion of the Related Art

In a typical computing system, every CPU can access all of RAM, either directly with Load and Store instructions, or indirectly, such as with a message passing scheme.

When more than one CPU can access or manage a RAM subsystem or portion thereof, certain accesses to that RAM, specifically allocation and deallocation of RAM for use by the Operating System or some application, must be synchronized to ensure mutually exclusive access to the data structures tracking memory allocation and deallocation by the CPUs. This in turn generates contention for those data structures between multiple CPUs and thereby reduces overall system performance.

Heretofore, the requirement of mutually exclusive access to memory management data structures with low contention between CPUs referred to above has not been fully met. What is needed is a solution that addresses this requirement.

### SUMMARY OF THE INVENTION

There is a need for the following embodiments. Of course, the invention is not limited to these embodiments.

According to a first aspect of the invention, a method comprises: receiving a request from a requesting software to allocate a segment of memory; scanning a data structure for a smallest suitable class size, the data structure including a list of memory address size classes, each memory address size class having a plurality of memory addresses; determining whether the smallest suitable size class is found; if the smallest suitable size class is found, determining whether memory of the smallest suitable size class is available in the data structure; if the smallest suitable size class is found, and if memory of the smallest suitable size class is available, selecting a memory address from among those memory addresses belonging to the smallest suitable size class; and if the smallest suitable size class is found, and if memory of the smallest suitable size class is available in the data structure returning the memory address to the requesting software. According to a second aspect of the invention, an apparatus comprises: a processor; a private memory coupled to the processor; and a data structure stored in the private memory, the data structure including a list of memory address size classes wherein each memory address size class includes a plurality of memory addresses.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a two CPU computer system, representing an embodiment of the invention.

FIG. 2 illustrates key features of a computer program, representing an embodiment of the invention.

FIG. 3 illustrates a flow diagram of a process that can be implemented by a computer program, representing an embodiment of the invention.

FIG. 4 illustrates another flow diagram of a process that can be implemented by a computer program, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

The below-referenced U.S. patent applications disclose embodiments that were satisfactory for the purposes for which they are intended. The entire contents of U.S. Ser. Nos. 09/273,430, filed Mar. 19, 1999; 09/859,193, filed May 15, 2001; 09/854,351, filed May 10, 2001; 09/672,909, filed Sep. 28, 2000; 09/653,189, filed Aug. 31, 2000; 09/652,815, filed Aug. 31, 2000; 09/653,183, filed Aug. 31, 2000; 09/653,425, filed Aug. 31, 2000; 09/653,421, filed Aug. 31, 2000; 09/653,557, filed Aug. 31, 2000; 09/653,475, filed Aug. 31, 2000; 09/653,429, filed Aug. 31, 2000; 09/653,502, filed Aug. 31, 2000; (Attorney Docket No. TNSY:017US), filed Jul. 25, 2001; (Attorney Docket No. TNSY:018US), filed Jul. 25, 2001; (Attorney Docket No. TNSY:020US), filed Jul. 25, 2001; (Attorney Docket No. TNSY:021US), filed Jul. 25, 2001; (Attorney Docket No. TNSY:022US), filed Jul. 25, 2001; (Attorney Docket No. TNSY:023US), filed Jul. 25, 2001; (Attorney Docket No. TNSY:024US), filed Jul. 25, 2001; and (Attorney Docket No. TNSY:026US), filed Jul. 25, 2001 are hereby expressly incorporated by reference herein for all purposes.

The context of the invention can include computer systems featuring shared memory, wherein management of the shared memory is carried out through data structures containing information about usage of each shared memory segment.

In a computer system for which the memory (RAM) subsystem or a portion thereof is connected to one or more central processing units (CPU), methods and apparatus are disclosed for reducing RAM subsystem contention and efficiently and correctly processing memory allocation and deallocation from the RAM subsystem.

In a computer system where more than one CPU has access to the RAM subsystem, or portion thereof, mutually exclusive access to the data structures used to track memory allocation and deallocation among the multiple CPUs must be provided. Traditionally, this is done with spinlocks, Test-And-Set registers, or bus locking mechanisms. In any of these scenarios, while a CPU is manipulating these specific data structures, if another CPU also needs to manipulate these data structures, the other CPU(s) must wait until the first CPU is finished, thus keeping the other CPUs from performing other work, and thereby reducing the performance of the overall computer system.

In a computer system where each CPU has private access to a portion of the RAM subsystem, such that the other CPUs can not, or at least do not, access that portion of the RAM subsystem, a methodology can be designed where the possibility of more than one CPU needing to access the memory management data structures simultaneously is lowered, thereby reducing contention for those data structures, and thus increasing overall computer system performance.

Scadamalia et al in U.S. Ser. No. 09/273,430, filed Mar. 19, 1999 have described a system in which each computer node has its own, private memory, but in which there is also provided a shared global memory, accessible by all computer nodes. In this case, contention for shared memory data structures only occurs when more than one node is attempting to allocate or deallocate some shared memory at the same time. It is also possible in a traditional symmetric multiprocessor (SMP) where all memory is shared among all CPUs, that if each CPU reserves a portion of RAM and that no other processor accesses that portion, then the techniques described by this invention also apply to that computer system. It obvious to one skilled in the art that other distributed, shared computer systems, including but not limited to cc-NUMA, benefit from the techniques discussed herein.

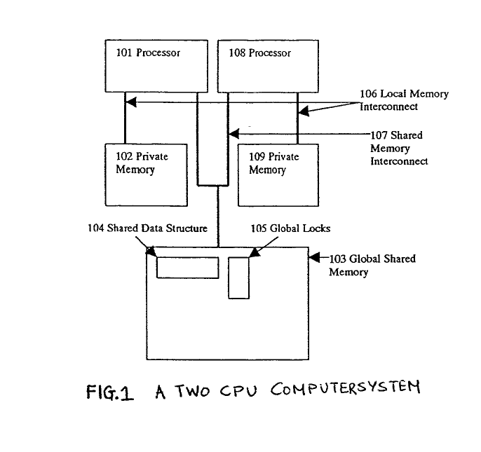

A computer system of the type discussed in U.S. Ser. No. 09/273,430, filed Mar. 19, 1999 can be designed with each CPU able to allocate or reserve and deallocate or release global shared memory for its use. The data structures describing the usable shared memory may reside in shared memory, though that is not necessary. When a CPU allocates or deallocates shared memory, some form of inter-CPU synchronization for purposes of mutual exclusion must be used to maintain the integrity of the data structures involved. FIG. 1 shows such a computer system, with multiple CPUs, each with private RAM as well as access to global shared RAM, and where the data structures for managing shared memory as well as the synchronization primitives required for said management may be located in such a system. However, the techniques described herein apply equally to computer systems where the data structures used to manage shared memory and/or the synchronization techniques are not located in global shared memory.

Referring to FIG. 1, a two CPU computer system is shown. The two CPU computer system includes a first processor 101 and a second processor 108. The first processor 101 is coupled to a first private memory unit 102 via a local memory interconnect 106. The second processor 108 is coupled to a second private memory unit 109 also via the local memory interconnect 106. Both the first and second processors 101 and 108 are coupled to a global shared memory unit 103 via a shared memory interconnect 107. The global shared memory unit 103 includes shared memory data structures 104 and global locks 105, which must be opened by software attempting to access the shared memory data structures 104.

Still referring to FIG. 1, elements 101 and 108 are standard CPUs. This illustration represents a two CPU computer system, namely elements 101 and 108, but it is obvious to one skilled in the art that a computer system can comprise more than two CPUs.

Element 102 is the private memory that is only accessed by element 101. This illustration represents a system in which the CPUs do not have access to the private memories of the other CPUs, but it will be obvious to one skilled in the art, that even if a private memory can be accessed by more than one CPU, the enhancements produced by the invention will still apply.

Element 103 is the global shared memory that is accessible, and accessed, by a plurality of CPUs. Even though this invention applies to single CPU computer systems, the benefits of this invention are not realized in such a configuration since contention for memory by more than one CPU never occurs. However, it is possible to extend the techniques taught by the invention down to the process level, or thread level, where a given process or thread may have private storage that is not accessed by another process or thread, and memory allocation and deallocation performed by each process or thread could be managed in such a way as to reduce inter-process or inter-thread contention for the memory management data structures, where the processes or threads are running on a single CPU system, or a multiple CPU system.

Element 104 shows that the data structures for managing the allocation and deallocation in this computer system are actually located in the globally shared memory area also. However, it should be obvious to one skilled in the art that the data structures used to manage allocation and deallocation from the global shared memory area could be located in the private memory of a single CPU, or even distributed and synchronized across a plurality of CPUs.

Element 105 shows the synchronization mechanism used in this computer system for enforcing mutually exclusive access to the data structures used to manage shared memory allocation and deallocation is a set of one or more locks, located in global shared memory space, accessible to all CPUs. It is obvious to one skilled in the art that the synchronization mechanism could be performed by using a bus locking mechanism on element 107, a token passing scheme used to coordinate access to the shared data structures among the different CPUs, or any of a number of different synchronization techniques. This invention does not depend on the synchronization technique used, but it more easily described while referencing a given technique.

Element 106 is the connection fabric between CPUs and their private memories, and element 107 is the connection fabric between CPUs and global shared memory. The computer system described by this illustration shows these two interconnect fabrics as being separate, but access to private memory and global shared memory could share the same interconnect fabric.

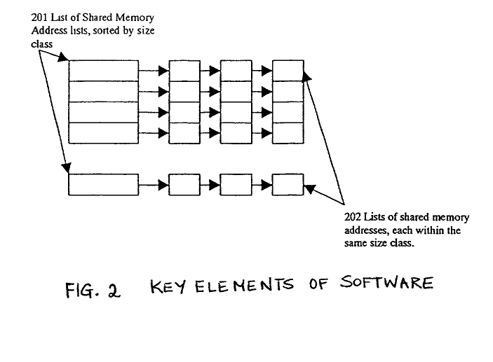

FIG. 2 shows a representation of the key elements of a software subsystem described herein. With reference thereto, element 201 is a data structure that maintains a list of memory allocation size classes, and within each class, element 202 is a list of available shared memory allocation addresses that may be used to satisfy a shared memory allocation request. This data structure is stored in the private memory of each CPU, and hence access to this data structure does not need to be synchronized with the other CPUs in the computer system.

Referring again to FIG. 2, a data structure containing a list of shared memory address size classes 201 is shown. Each shared memory address size class 201 further contains a list of shared memory addresses 202 which belong to the same shared memory address size class 201. There are many different algorithms that one skilled in the art can use to implement the data structures shown in FIG. 2 and the key functions described above. Algorithms include, but are not limited to singly linked lists, doubly linked lists, binary trees, queues, tables, arrays, sorted arrays, stacks, heaps, and circular linked lists. For purposes of describing the functionality of the invention, a Sorted Array of Lists is used, i.e., size classes are contained in a sorted array, each size class maintaining a list of shared memory addresses that can satisfy an allocation request of any length within that size class.

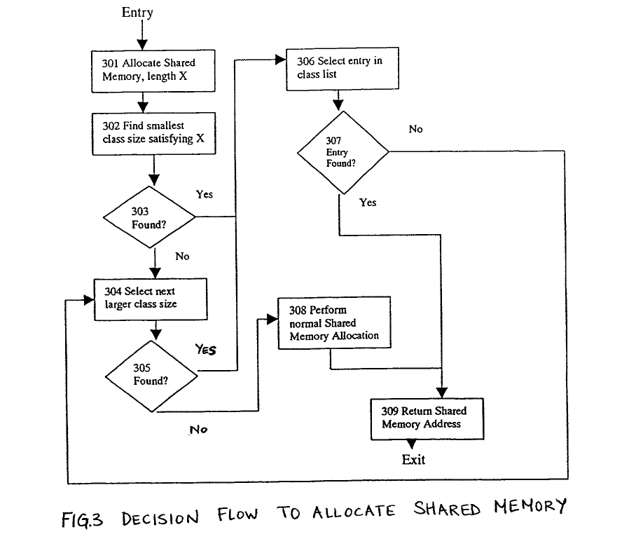

Referring to FIG. 3, a decision flow for allocating a shared memory segment of length X is shown. The decision flow is entered when a processor receives a request from software to allocate shared memory of length X 301. Upon receiving the request for shared memory, control passes to a function to find a smallest size class satisfying the length X 302, as requested by software. The processor searches for a smallest suitable size class by scanning a data structure of the type shown in FIG. 2. The processor then determines whether a smallest suitable size class has been found 303. If a smallest suitable size class is found, then the processor selects an entry in the smallest suitable size class 306. If the entry in the smallest suitable size class is found, the processor returns a shared memory address to the requesting software 309. If the entry in the smallest suitable size class is not found, or if the smallest suitable size class is not found, the processor scans a data structure of the type shown in FIG. 2 for a next larger size class 304. The processor then determines whether a next larger size class has been found 305. If a next larger size class is found, then the processor selects an entry in the next larger size class 306. If the entry in the next larger size class is found, then the processor returns a shared memory address to the requesting software 309. If the entry in the next larger size class is not found, the processor searches for yet another next larger size class. When no next larger size classes are found, the processor performs normal shared memory allocation 308, and returns a shared memory address to the requesting software 309.

FIG. 3 shows a decision flow of an application attempting to allocate global shared memory. With reference thereto, element 301 is the actual function call the application makes. There are various parameters associated with this call, but for the purposes of this invention, the length of shared memory is the key element. However, it is obvious to one skilled in the art that numerous sets of data structures as shown in FIG. 2 may be kept, each with one or more distinct characteristics described by one or more of the parameters passed to the allocation function itself. These characteristics include, but are not limited to, exclusive versus shared use, cached versus non-cached shared memory, memory ownership flags, etc.

Element 302 implements the scan of the sorted array, locating the smallest size class in the array that is greater than or equal to the length “X”, requested. (e.g. if X was 418, and three adjacent entries in the sorted array contained 256, 512, and 1024, then the entry corresponding to 512 is scanned first, since all shared memory address locations stored in that class are of greater length than 418. In this example, using 256 produced undefined results, and using 1024 wastes shared memory resources.)

Element 303 is a decision of whether a size class was found in the array that represented shared memory areas greater than or equal to X. If an appropriate size class is located, then element 306 is the function that selects an available address from the class list to satisfy the shared memory request. If an entry is found, that address is removed from the list, and element 309 provides the selected shared memory address to the calling application.

Element 304 is the function that selects the next larger size class from the previously selected class size, to satisfy the request for shared memory. If there is no larger size class available, the normal shared memory allocation mechanism shown in element 308 is invoked, which then returns the newly allocated shared memory address to the calling function by element 309. Element 308 includes all of the synchronization and potential contention described above, but the intent of this invention is to satisfy as many shared memory allocation requests through element 306 as possible, thereby reducing contention as much as possible. If in fact no shared memory allocation request is ever satisfied by element 306, then a negligible amount of system overhead, and no additional contention is introduced by this invention. Therefore, in a worst case scenario, overall system performance is basically unaffected, but with a best case possibility of reducing shared memory data structure contention to almost zero.

It is obvious to one skilled in the art that certain enhancements could be made to the data flow described in FIG. 3, including, but not limited to, directly moving from element 303 to element 308 if no size class was found, as well as using binary searches, hashes, b-trees, and other performance related algorithms to minimize the system overhead of trying to satisfy a request from element 301 up through element 309.

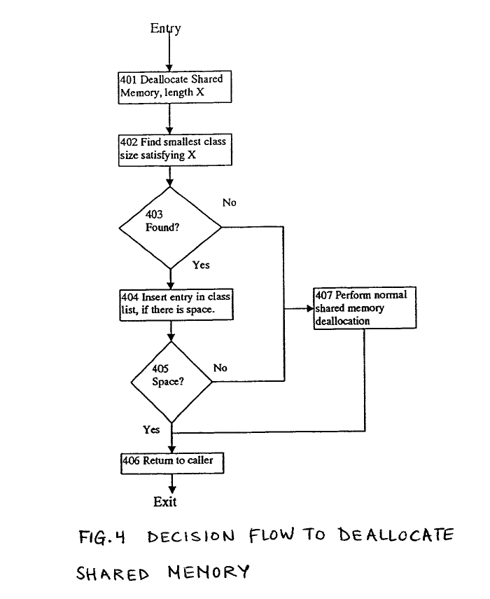

Referring to FIG. 4, a decision flow for deallocating a shared memory segment of length X is shown. The decision flow is entered when a processor receives a request from software to deallocate shared memory of length X 401. Upon receiving the request for deallocation of shared memory, control passes to a function to find a smallest size class satisfying the length X 402. The processor then searches for a smallest suitable size class by scanning a data structure of the type shown in FIG. 2. The processor then determines whether a smallest suitable size class has been found 403. If a smallest suitable size class is found and if there are enough system resources available 405, the processor inserts a new entry into a size class list 404, contained in a data structure of the type shown in FIG. 2. If sufficient system resources are not available, or if a smallest size class is not found, the processor performs normal shared memory deallocation 407, bypassing use of a data structure to reduce contention for access to shared resources. If there are sufficient resources available, the program returns control to a caller 406.

FIG. 4 shows a decision flow of an application attempting to deallocate global shared memory. With reference thereto, element 401 is the actual function call the application makes. There are various parameters associated with this call, but for the purposes of this invention, the length of shared memory is the key element. The length may not actually be passed with the function call, yet accessing the shared memory data structure in a Read Only fashion will yield the length of the memory segment, and usually, no contention is encountered while accessing this information. It is obvious to one skilled in the art that numerous sets of data structures as shown in FIG. 2 may be kept, each with one or more distinct characteristics described by one or more of the parameters passed to the deallocation function itself. These characteristics include, but are not limited to, exclusive versus shared use, cached versus non-cached shared memory, memory ownership flags, etc.

Element 402 implements the scan of the sorted array, locating the largest size class in the array that is less than or equal to the length “X”, requested. (e.g. if X was 718, and three adjacent entries in the sorted array contained 256, 512, and 1024, then the entry corresponding to 512 is used, since all shared memory address locations stored in that class are of length greater than 512. In this example using 256 wastes shared memory resources, and using 1024 produces undefined results.)

Element 403 determines if an appropriate size class was found. It is obvious to one skilled in the art that dynamically creating new size class lists is feasible, but for the purposes of this discussion, we shall assume the size class list is complete enough such that storing entries for larger class sizes in each CPU of the computer system might be detrimental to overall system performance by reducing available shared memory resources in the extreme. In these cases, when very large shared memory regions are released to global shared memory, they should be returned to the available pool of shared memory immediately, rather than being managed in private memory spaces of each CPU. Computer system characteristics and configurations are used to determine the largest size class managed in the private memory of each CPU, but an example of a complete list of class sizes includes, but is not limited to: 64, 128, 256, 512, 1024, 2048, 4096, 8192, 16384, 32768, and 65536.

Element 404 inserts the entry into the selected size class list, provided there is room left for the insertion. Room may not be left in the size class lists if they are implemented as fixed length arrays, and all the available spaces in the array are occupied. Also, the size class lists may be artificially trimmed to maintain a dynamically determined amount of shared memory based on one or more of several criteria, including but not limited to: class size, size class usage counts, programmatically configured entry lengths or aggregate shared memory usage, etc.

Element 405 directs the flow of execution based on whether space was available for the insertion of the shared memory address onto the list, or not. If space was available, the proceeding to element 406 returns control back to the calling application. If either element 403 or 405 determined a false result, then control is passed to element 407. Element 407 includes all of the synchronization and potential contention described above, but the intent of this invention is to be able to satisfy as many shared memory deallocation requests through element 405 as possible, thereby reducing contention as much as possible. If in fact, no shared memory deallocation request were ever satisfied by element 403 or 405, then only a negligible amount of system overhead, an no additional contention would be introduced by the invention.

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

While not being limited to any particular performance indicator or diagnostic identifier, preferred embodiments of the invention can be identified one at a time by testing for the absence of contention between CPUs for access to memory management data structures. The test for the presence of contention between CPUs can be carried out without undue experimentation by the use of a simple and conventional memory access experiment.

### Practical Applications of the Invention

A practical application of the invention that has value within the technological arts is in multiple CPU environments, wherein each CPU has access to a global memory unit. Further, the invention is useful in conjunction with servers (such as are used for the purpose of website hosting), or in conjunction with Local Area Networks (LAN), or the like. There are virtually innumerable uses for the invention, all of which need not be detailed here.

### Advantages of the Invention

Distributed shared memory management, representing an embodiment of the invention, can be cost effective and advantageous for at least the following reasons. The invention improves quality and/or reduces costs compared to previous approaches. This invention is most valuable in an environment where there are multiple compute nodes, each with one or more CPU and each CPU with private RAM, and where there are one or more RAM units which are accessible by some or all of the computer nodes. The invention increases computer system performance by drastically reducing contention between CPUs for access to memory management data structures, thus freeing the CPUs to carry out other instructions instead of waiting for the opportunity to access the memory management data structures.

All the disclosed embodiments of the invention disclosed herein can be made and used without undue experimentation in light of the disclosure. Although the best mode of carrying out the invention contemplated by the inventor(s) is disclosed, practice of the invention is not limited thereto. Accordingly, it will be appreciated by those skilled in the art that the invention may be practiced otherwise than as specifically described herein.

Further, variation may be made in the steps or in the sequence of steps composing methods described herein.

Further, although the global shared memory unit described herein can be a separate module, it will be manifest that the global shared memory unit may be integrated into the system with which it is associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
receiving a request from a requesting software to allocate a segment of memory;
scanning a data structure for a smallest suitable class size, the data structure including a list of memory address size classes, each memory address size class having a plurality of memory addresses;
determining whether the smallest suitable size class is found;
if the smallest suitable size class is found, determining whether memory of the smallest suitable size class is available in the data structure;
if the smallest suitable size class is found, and if memory of the smallest suitable size class is available, selecting a memory address from among those memory addresses belonging to the smallest suitable size class; and
if the smallest suitable size class is found, and if memory of the smallest suitable size class is available in the data structure returning the memory address to the requesting software.

2. The method of claim 1, wherein the data structure is resident in a private memory of each processor in a multiprocessor configuration.

3. The method of claim 1, further comprising: if the smallest suitable size class is not found,
scanning the data structure for a next larger suitable size class;
determining whether the next larger suitable size class has been found;
if the next larger suitable size class is found, selecting a memory address from the next larger suitable size class; and
if the next larger suitable size class is found, returning the memory address to the requesting software.

4. A method, comprising:
receiving a request from a requesting software to deallocate a segment of memory;
scanning a data structure for a smallest suitable size class, the data structure including a list of memory address size classes, each memory address size class having a plurality of memory addresses;
determining whether the smallest suitable size class is found;
if the smallest suitable size class is found, creating a new entry of the smallest suitable size class in the data structure;
if the smallest suitable size class is found, and if memory of the smallest suitable size class is available, denoting the new entry in a memory address of the smallest suitable size class in the data structure; and
if the smallest suitable size class is found, and if memory of the smallest suitable size class is available, inserting the new entry into the data structure.

5. The method of claim 4, further comprising deallocating the segment of memory without inserting the new entry into the data structure, if a smallest suitable size class is not found, or if memory of the smallest suitable size class is not available.

6. An apparatus, comprising:
a processor;
a private memory coupled to the processor; and
a data structure stored in the private memory, the data structure including a list of memory address size classes wherein each memory address size class includes a plurality of memory addresses.

7. The apparatus of claim 6, wherein the processor includes a device selected from the group consisting of microprocessors, programmable logic devices, and microcontrollers.

8. The apparatus of claim 6, further comprising another processor coupled to the processor.

9. The apparatus of claim 6, further comprising:
a global shared memory coupled to the processor; and
another data structure stored in the global shared memory, the another data structure including a list of memory address size classes.

10. The apparatus of claim 9, wherein the global shared memory can be accessed by a plurality of processors.

11. The apparatus of claim 6, wherein the private memory can be accessed by a plurality of processors.

12. The apparatus of claim 6, wherein the data structure includes at least one member selected from the group consisting of singly linked lists, doubly linked lists, binary trees, queues, tables, arrays, sorted arrays, stacks, heaps, and circular linked lists.

13. The apparatus of claim 9, wherein the data structure includes at least one member selected from the group consisting of singly linked lists, doubly linked lists, binary trees, queues, tables, arrays, sorted arrays, stacks, heaps, and circular linked lists.
